(19) United States
(12) Patent Application Publication
(10) Pub. No.: US 2008/0214178 A1
(43) Pub. Date: Sep. 4, 2008

(54) Method for Optimizing Receipt Notification Information Interchange in Synchronous Communication Between Terminal and Network and Mobile Terminal

(76) Inventors: Michael Roberts, Neuilly sur Seine (FR); Frank Savaglio, Paris (FR)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/883,786

(22) PCT Filed: Apr. 5, 2006
(86) PCT No.: PCT/JP2006/007214

§ 371 Date: Oct. 22, 2007

(30) Foreign Application Priority Data
Apr. 18, 2005 (FR) 0550910

(51) Int. Cl. H04Q 7/20

(52) U.S. Cl. 455/422.1

(57) ABSTRACT

To optimize the interchange of an ACK signal and a NACK signal between a terminal and a network and reduce the conflict on the terminal level. The invention relates to a method for optimizing the interchange of a receipt notification signal between a plurality of base stations and a mobile terminal synchronously connected in a cellular communication network. The method comprises a step of estimating the quality of down-link between each base station and the terminal on at least one standardized transmission channel, and a step of retransmitting data to the base station depending on the estimated quality of link.

### TECHNICAL FIELD

The present invention pertains to a method for optimizing the receipt notification information interchange in the synchronous communication between a terminal and a network in the field of telecommunication and a mobile terminal, and particularly to a method for optimizing the interchange of data receipt notification signal between a mobile terminal and a plurality of base stations in a cellular communication network during radio synchronous connection.

Also, the invention pertains to a mobile terminal for communicating with a plurality of base stations in a cellular communication network.

### BACKGROUND ART

To allow high speed communications via a cellular network for the mobile terminal, a 3 GPP (Third generation partnership project) group specification employs a similar configuration to an HSDPA (High Speed Downlink Packet Access) service that provides a transmission rate of up to 2 Mbits/sec via an uplink dedicated channel EUDCH (Enhanced Uplink Dedicated Channel) or an HSUPA (High Speed Uplink Packet Access) service for future multimedia applications in a UMTS (next mobile telephone system). To automatically manage the report of receipt notification between the terminal and the base station, the 3 GPP group specification further specifies that an HARQ (Hybrid Automatic Request) layer of additional protocol is added at the level of a MAC (Medium Access Control) sublayer of layer 2 in the protocol for radio interface.

A new HARQ protocol layer is configured to transmit an ACK positive acknowledge receive signal to the base station in the network when the base station properly receives the packet transmitted from the terminal, or a NACK negative acknowledge signal when the base station does not properly receive the packet. In case of a transmission error, the terminal has to retransmit the packet in close liaison with the network.

The 3 GPP group specification specifies that all the cells involving the communication with the terminal should explicitly transmit an ACK positive acknowledge receipt notification in the appropriate transmission. As a result, in making the synchronous connection, if the terminal could always estimate the connection state to know whether transmit data is properly received, the channel would be occupied uselessly.

Moreover, it is advantageous that the base station does not need to retransmit the ACK signal, as far as the number of ACK is 90%, and the number of NACK is about 10% to 20%.

### DISCLOSURE OF THE INVENTION

An object of the invention is to provide a method for optimizing receipt notification information interchange in the synchronous communication between a terminal and a network, and a mobile terminal in which the number of useless ACK signals can be reduced.

The above object is accomplished by a method for optimizing the interchange of a receipt notification signal between a plurality of base stations and a mobile terminal synchronously connected in a cellular communication network, in which the base station transmits only the NACK signal indicating a transmission error to the terminal.

The method according to the invention comprises a step of estimating the quality of down-link between each base station and a terminal on at least one standardized transmission channel, a step of receiving the communication depending on the estimated quality of link, and a step of retransmitting data to the base station depending on the estimated quality of link.

With the method according to the invention, it is possible to avoid a situation where the base station transmits an ACK signal unnecessarily and save the electric power. As a result, the conflict on the system level is reduced.

In a first variation of the method according to the invention, the terminal retransmits data only if the estimated quality of all the links is below a predetermined value.

In a second variation of the method according to the invention, the terminal retransmits data if the estimated quality of at least one link is below the predetermined value and all other base stations transmit a negative acknowledge NACK receipt notification to the terminal.

The invention is carried out by a mobile terminal for communicating with a plurality of base stations in a cellular communication network.

The terminal according to the invention comprises means for estimating the quality of down-link for each base station on at least one standardized transmission channel, and means for determining to repeat the retransmission of data to the base station depending on the estimated quality.

If the quality of link is good, the terminal considers that the data packet has been received correctly.

Preferably, the invention is carried out in the network based on a WCDMA technique.

With the method for optimizing receipt notification information interchange in the synchronous communication between the terminal and the network, and with the mobile terminal according to the invention, it is possible to optimize the interchange of an ACK signal and a NACK signal between the terminal and the network and reduce the conflict on the terminal level.

### BRIEF DESCRIPTION OF THE DRAWINGS

FIG. 1 is a view schematically showing a first situation where a method according to the present invention is performed;

FIG. 2 is a view schematically showing a second situation where the method according to the present invention is performed; and

FIG. 3 is a view schematically showing a third situation where the method according to the present invention is performed.

### EXEMPLARY EMBODIMENTS

The following description involves carrying out the present invention in a network based on a WCDMA technique. More correctly, the invention will be described in a UMTS network.

Discussing anew the UMTS, a radio interface includes three primary layers of

physical layer (layer 1),

data connection layer (layer 2), and

control layer (RRC) for radio resource.

The layer 2 comprises four sublayers of

MAC (Medium Access Control) sublayer,

RLC (Radio Link) sublayer,

PDPC (Packet Data Convergence Protocol) sublayer, and

BMC (Broadcast/Multicast Protocol) sublayer.

A new HARQ protocol layer for controlling the report of receipt notification between the base station and the terminal is provided on the MAC sublayer.

In the UMTS, the network transmits the first and second synchronization codes via a first channel PSCH (Primary Synchronization Channel) and a second channel SSCH (Secondary Synchronization Channel) to the terminal within the current cell at any time to identify an adjacent UMTS cell and estimate a pulse response on the transmission channel via a beacon channel called a CPICH (Common Pilot Channel). The CPICH channel comprises a predetermined bit/symbol sequence, called a pilot sequence, transmitted to the cell at any time. The transmission amount of bit/symbol is fixed, viz., 30 kbps (kilo bits/sec), or 15 kbps (kilo symbols/sec). The CPICH channel is not connected to any transmission channel. The terminal can decode the CPICH channel and evaluate the quality of down-link, while waiting for a NACK receipt notification of the cell in the network during synchronous communication. Therefore, the terminal comprises a measurement module for estimating the quality of connection with the base station via the CPICH channel and a module for determining to perform the retransmission of data to the base station depending on the estimated quality. Discussing anew the synchronous connection, a transmission block is necessarily exchanged between the network and the terminal during the TTI (Transmission Time Interval) time.

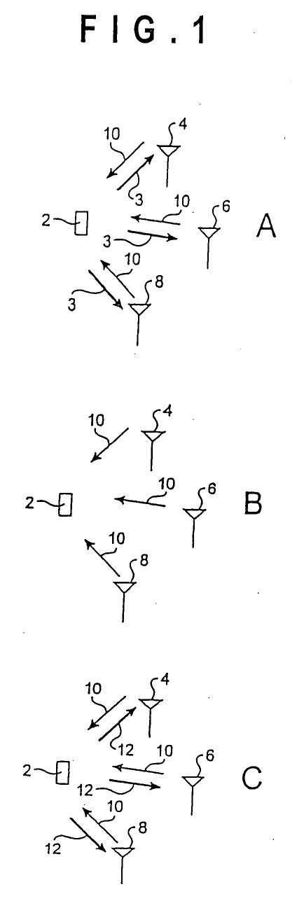

FIG. 1 schematically shows a mobile terminal 2 that communicates synchronously with three base stations 4, 6 and 8 in a network, in which all the base stations have properly received data transmitted from the terminal 2.

Referring to FIG. 1A, the terminal 2 sends a data packet to the base stations 4, 6 and 8 (arrow 3), and on a parallel with this, receives a bit/symbol pilot sequence via the CPICH channel from each of the base stations (arrow 10).

In FIG. 1B, the terminal 2 determines the power of a signal received from each of the base stations 4, 6 and 8 by analyzing the bit/symbol transmitted via the CPICH channel during the waiting period of a receipt notification signal, and compares the measured power with a predetermined threshold power. If the measured power for each of the base stations is greater than the threshold, the determination module presumes that each of the base stations 4, 6 and 8 has properly received the packet sent from the terminal 2 (FIG. 1C, arrow 12), to send the next packet without waiting for an ACK signal. In this system, the terminal infers an ACK signal implicitly included from the measured value performed on the CPICH channel. Therefore, each of the base stations 4, 6 and 8 does not need to explicitly send the ACK signal to the terminal during synchronous connection. Thereby, the power can be saved on the down-link and allocated to another function.

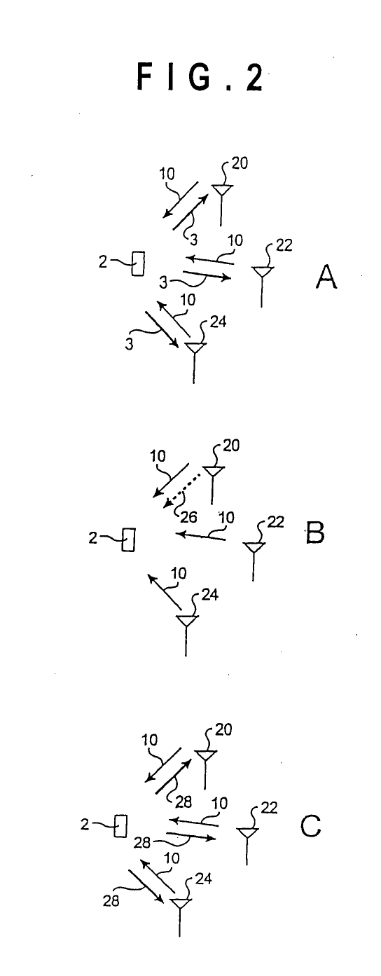

FIG. 2 schematically shows a second situation where some base stations have not properly received data transmitted from the terminal.

Referring to FIG. 2A, the terminal 2 sends a data packet to each of the base stations 20, 22 and 24 (arrow 3), and on a parallel with this, receives a bit/symbol pilot sequence via the CPICH channel from each of the base stations (arrow 10). In this case, the base station 20 sends a NACK signal to the terminal 2 (FIG. 2B, arrow 26). The terminal 2 determines the power of a signal received from each of the base stations 20, 22 and 24 by analyzing the bit/symbol transmitted via the CPICH channel during the waiting period of a receipt notification signal, and compares the measured power with a predetermined threshold power. If the measured power for each base station is greater than the threshold, the determination module presumes that at least the base station 24, 26 have properly received the packet sent from the terminal 2 (FIG. 2C), to send the next packet in accordance with the arrow 28 without waiting for the ACK signal. No consideration is given to the NACK signal (arrow 26) sent from the base station 20. The base stations 20, 22 and 24 continue to send the bit/symbol to the terminal 2 via the CPICH channel (arrow 10).

In this case, the method according to the invention makes it possible to consider the fading under the physical transmission conditions of the signal sent from the base station 20, and avoid retransmitting the packet if the base stations 22 and 24 have properly received the sent packet.

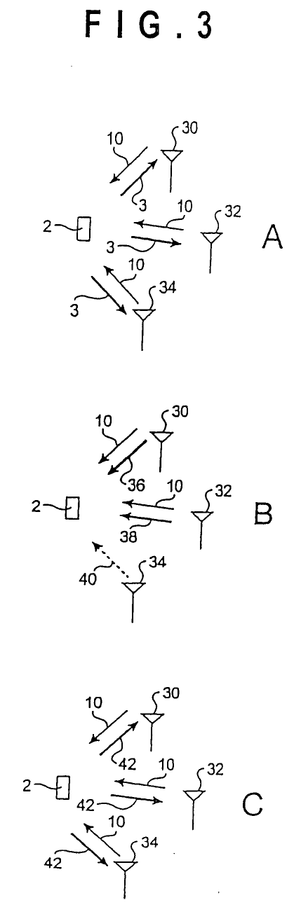

FIG. 3 schematically shows a third situation where none of the base stations have properly received data transmitted from the terminal.

Referring to FIG. 3A, the terminal 2 sends a data packet to the base stations 30, 32 and 34 (arrow 3), and on a parallel with this, receives a bit/symbol pilot sequence via the CPICH channel from each of the base stations (arrow 10). In this case, two base stations 30 and 32 send a NACK signal to the terminal 2 (FIG. 3B, arrows 36 and 38). The terminal 2 determines the power of a signal received from each of the base stations 30, 32 and 34 by analyzing the bit/symbol transmitted via the CPICH channel during the waiting period of a receipt notification signal, and compares the measured power with a predetermined threshold power. In this case, if the measured power (arrow 40) of the signal received from the base station 34 is smaller than the threshold, the determination module presumes that none of the base stations 30, 32 and 34 have properly received the packet sent from the terminal 2. The terminal retransmits the same packet to the base station 34 (FIG. 3C, arrow 42), and makes the measurements again for the signals (arrow 10) transmitted from the base stations via the CPICH channel. This operation is repeated until at least one of the base stations 30, 32 and 34 properly receives the packet sent from the terminal 2.

1. A method for optimizing receipt notification information interchange in the synchronous communication between a terminal and a network to optimize interchange of a receipt notification signal between a plurality of base stations and a mobile terminal synchronously connected in a cellular communication network, said method comprising:
estimating quality of down-link between each base station and the terminal on at least one standardized transmission channel; and
retransmitting data to the base station depending on said estimated quality of link.

2. The method for optimizing receipt notification information interchange in the synchronous communication between the terminal and the network according to claim 1, wherein said terminal retransmits data only if the estimated quality of all the connections is below a predetermined value.

3. The method for optimizing receipt notification information interchange in the synchronous communication between the terminal and the network according to claim 1, wherein said terminal retransmits data only if the estimated quality of at least one connection is below the predetermined value and all other base stations send a negative acknowledge NACK receipt notification to the terminal.

4. The method for optimizing receipt notification information interchange in the synchronous communication between the terminal and the network according to claim 1, wherein said network is based on a WCDMA technique.

5. The method for optimizing receipt notification information interchange in the synchronous communication between the terminal and the network according to claim 4, wherein said network is the UMTS network.

6. The method for optimizing receipt notification information interchange in the synchronous communication between the terminal and the network according to claim 1, wherein said standardized transmission channel is a CPICH channel.

7. A mobile terminal for communicating with a plurality of base stations in a cellular communication network, comprising:
means for estimating the quality of down-link for each base station on at least one standardized transmission channel; and
means for determining to repeat the retransmission of data to the base station depending on said estimated quality.

8. The mobile terminal according to claim 7, further comprising comparison means for comparing the estimated quality with a predetermined value.
